(19) United States
(12) Patent Application Publication
(10) Pub. No.: US 2023/0104463 A1
(43) Pub. Date: Apr. 6, 2023

(54) MOLDED FLUIDIC DIE ASSEMBLIES

(71) Applicant: Hewlett-Packard Development Company, L.P., Spring, TX (US)

(72) Inventors: Kenneth James Faase, Corvallis, OR (US); Zhuqing Zhang, Corvallis, OR (US); Randy Hoffman, Corvallis, OR (US); Gary G. Lutnesky, Corvallis, OR (US)

(73) Assignee: Hewlett-Packard Development Company, L.P., Spring, TX (US)

(21) Appl. No.: 17/911,557

(22) PCT Filed: Apr. 1, 2020
(86) PCT No.: PCT/US2020/026076

§ 371 Date: Sep. 14, 2022

(51) Int. Cl. B05C 5/02

(52) U.S. Cl. CPC B05C 5/02

(57) ABSTRACT

An example molded fluidic die assembly includes a fluidic die including an electrical component and a fluidic architecture on a first face of the fluidic die, the fluidic architecture including a front face; circuitry; an electrical connection coupling the circuitry to the electrical component on the first face of the fluidic die; and a continuous molded compound that surrounds the fluidic die and encompasses the electrical connection.

### BACKGROUND

Fluid ejection devices can be used for manipulation and testing of fluids. For instance, fluids can be ejected from a fluidic die in the fluid ejection device.

A fluidic die can include electrical components. The electrical components can permit an electrical connection between the fluidic die and other components in the fluid ejection device. Examples of electrical components include wire traces, bond pads, etc. The electrical components can be protected, for instance, from electrical shorts and/or damage, using an encapsulation material. For instance, an adhesive or other encapsulation material that can be dispensed on the electrical components.

### BRIEF DESCRIPTION OF THE DRAWINGS

FIG. 1 is a diagram of an example fluid ejection device including an example molded fluidic die assembly according to the disclosure.

FIG. 2 is a cross-sectional view of a portion of an example molded fluidic die assembly according to the disclosure.

FIG. 3 is another cross-sectional view of a portion of an example molded fluidic die assembly according to the disclosure.

FIG. 4 is yet another cross-sectional view of a portion of an example molded fluidic die assembly according to the disclosure.

FIG. 5 is an additional cross-sectional view of a portion of an example molded fluidic die assembly according to the disclosure.

FIG. 6 is a further cross-sectional view of a portion of an example molded fluidic die assembly according to the disclosure.

FIG. 7 is a flow diagram of an example method of forming a molded fluidic die assembly according to the disclosure.

### DETAILED DESCRIPTION

As mentioned, electrical components (e.g., wire traces, bond pads, etc.) in a fluidic die can be protected with an encapsulation material. For instance, an encapsulation material such as an adhesive can be dispensed at ambient pressure onto an exposed surface of an electrical component. The dispensed encapsulation material can be intended to encapsulate and thereby protect the electrical component.

However, a dispensed encapsulation material, when cured or otherwise formed, can be discontinuous due to the presence of voids (e.g,, air filled voids) in the dispensed encapsulation material. Additionally, the dispensed encapsulation material can, by its presence, inherently create numerous interfaces between the dispensed encapsulation material and adjacent materials. Such voids and/or interfaces can lead to inadvertent exposure of the electrical component to fluid.

In addition, the presence of dispensed encapsulation material can lead to resultant structures where a fluidic die included in the resultant structures is recessed a large distance below the dispensed encapsulation material. For instance, a front face of the fluidic die can be recessed 250 or more micrometers below a top face of the dispensed encapsulation material. The large recess can result in a large fluidic die-to-media spacing.

In contrast, examples of the disclosure include molded fluidic die assemblies with a continuous molded compound that surrounds a fluidic die and encompasses an electrical connection that couples circuitry to an electrical component on a first face of the fluidic die. Molded fluidic die assemblies can protect a front face of a fluidic die from impact, and yet enable closer die-to-media spacing for enhanced print quality, in some implementations, Molded fluidic die assemblies herein can have a reduced total number and/or a reduced total linear distance of material interfaces for enhanced protection against ingress of fluids. Molded fluidic die assemblies herein can be shroud-free and/or can be adhesive-free, as detailed herein, Thus, molded fluidic die assemblies herein can have increased reliability, for instance, due to protecting the front face of fluidic die from impact, providing enhanced protection against fluid ingress, being shroud-free, and/or being adhesive free.

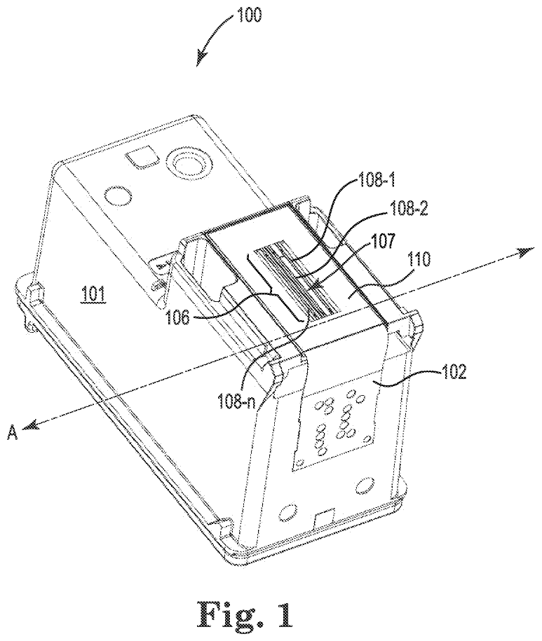

FIG. 1 is a diagram of an example fluid ejection device 100 including an example molded fluidic die assembly according to the disclosure. Fluid ejection device 100 can be any type of fluid ejection device such as a thermal fluid ejection device, piezoelectric fluid ejection device, and/or other type of fluid ejection device.

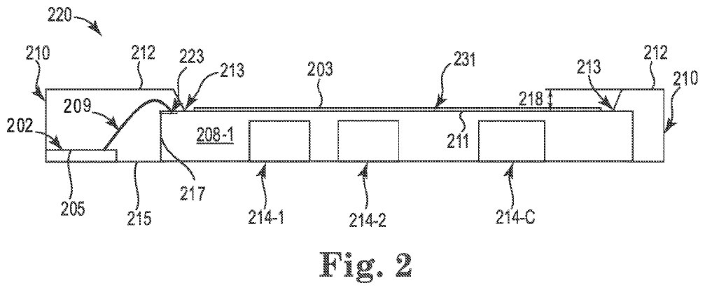

The fluid ejection device 100 can include a pen body 101 and a package 106. The package 106 can included a plurality of molded fluidic die assemblies (such as the molded fluidic die assembly represented by 107). Each of the molded fluidic die assemblies can include circuitry 102, a fluidic die such a fluidic die 108-1, 108-2, . . . , and/or 108-n (collectively referred to herein as fluidic die 108), and an electrical connection (e.g., electrical connection 209 as illustrated in FIG. 2) coupling the circuitry 102 to an electrical component on the first face of the fluidic die 108 (the face through which printing fluid is to be ejected), among other components, as detailed herein.

The circuitry 102 can be a printed circuit board (PCB), printed circuit assembly (PCA), flexible circuit, interposers, or other type circuitry. The circuitry 102 can include electrical components such as bond pads to permit coupling of the circuitry 102 to the fluidic die 108. In some examples, the fluidic die 108 can be thin silicon fluidic die or other type of fluidic die to permit ejection of printing fluid from the fluid ejection device 100.

While illustrated as being visible in FIG. 1, a portion of the circuitry 102 can be disposed in the continuous molded compound 110. Disposing the circuitry 102 in the continuous molded compound 110 refers to an individual face or a plurality of faces of the circuitry 102 being overlaid (entirely covered) by the continuous molded compound 110, while leaving the electrical interconnects uncovered. For instance, a top face (e.g., top face 205 as illustrated in FIG. 2) of the circuitry 102 can be overlaid by a continuous molded compound.

The electrical connection, as detailed herein, refers to any type of electrical connection that couples the fluidic die 108 to the circuitry 102. Examples of electrical connections includes a wire trace (i.e., a bond wire), solder joints, Tape Automated Bond (TAB), or combinations thereof. For instance, in some examples the electrical connection can be formed of a wire trace that couples an electrical component such as a bond pad or other structure in the fluidic die 108 to a corresponding electrical component in the circuitry 102.

As mentioned, the fluid ejection device 100 includes a continuous molded compound 110 that surrounds fluidic die 108 and that also encompasses the electrical connection. That is, the continuous molded compound 110 can surround a plurality of faces of the fluidic die 108, as illustrated in FIG. 1, and encompass the electrical connection, as detailed herein with respect to FIGS. 2-6.

Examples of suitable materials for the continuous molded compound 110 include an epoxy molding compound (EMC), a liquid crystal polymer (LCP), a polyethylene naphthalate (PEN), a polyethylene terephthalate (PET), a polyphenylene sulfide (PPS), a polyimide, a polymer, and/or a plastic, among others. For instance, in some examples the continuous molded compound 110 can be an EMC. In some examples the continuous molded compound 110 can be formed entirely of an EMC.

In some examples, the continuous molded compound 110 can have a glass transition temperature in a range from 120 to 220 degrees Celsius. All individual values and sub-ranges from 120 to 220 degrees Celsius are included. For instance, the continuous molded compound 110 can have a glass transition temperature in a range from 120 to 220, from 150 to 220, or from 170 to 220 degrees Celsius, etc. Having a high glass transition temperature in the range from 120 to 220 degrees Celsius can indicate stronger chemical bonding or higher cross-link density and thus higher resistance to ingress of printing fluid as compared to other materials (e.g., dispensed adhesives) which have a lower glass transition temperature. The glass transition temperature can be measured by Differential Scanning Calorimetry (DSC).

In some examples, the continuous molded compound 110 can have a Coefficient of Thermal Expansion (CTE) in a range from 7 parts part million (ppm) to 30 ppm. All individual values and sub-ranges from 7 to 30 ppm are included. For instance, the CTE of the continuous molded compound 110 can be in a range from 7 ppm to 10 ppm, 7 ppm to 20 ppm, or from 7 ppm to 30, etc. Having a CTE in the range of 7 to 30 ppm can reduce mechanical stress imparted on a molded fluidic die assembly due to temperature variations as compared to other materials (e.g., dispensed adhesives) with a higher CTE. The CTE can be measured by thermomechanical analysis (TMA),

In some examples, the fluid ejection device 100 can be adhesive-free and/or shroud-free, For instance, the fluid ejection device 100 can be adhesive-free and shroud-free. Being shroud-free refers to fluid ejection devices (and molded fluidic die assemblies) that do not include a shroud or other separate component (distinct from the continuous molded compound 110) that is adjacent to and intended to protect a fluidic die. Being adhesive-free refers to fluid ejection devices (and molded fluidic die assemblies) that do not include an adhesive or other separate encapsulation material (distinct from the continuous molded compound 110) that encapsulates an electrical connection. Being adhesive-free and/or shroud-free can provide enhanced reliability and/or ease of manufacture, in some instances,

FIG. 1 illustrates one circuit and one package (including a plurality of molded fluidic die assemblies). However, it is understood that a total number of circuits, packages, molded fluidic die assemblies, fluidic dies, relative size (e.g,, smaller, bigger, wider, deeper, shallower, longer, shorter, etc.), shape (e.g., rectangle, trapezoid, sinusoidal, etc.), relative orientation, and/or electrical connections, among other items, can be varied.

FIG. 2 is a cross-sectional view of a portion of an example molded fluidic die assembly 220 according to the disclosure, as viewed from cross-sectional line A in FIG. 1. As illustrated in FIG. 2, the molded fluidic die assembly 220 can include circuitry 202, a fluidic die 208-1, an electrical connection 209, a continuous molded compound 210, an electrical component 223, and a fluidic architecture 231 having a front face 203,

The fluidic architecture (as represented by element 231) refers to a collection of components that can permit ejection of fluid from the front face 203. For instance, fluidic architecture 231 can include fluid actuators (e.g., thermal resistors, piezo elements, etc.) and corresponding nozzles/ejection orifices, among other possible components. For example, actuation of the fluid actuators can cause fluid droplets to be ejected, via nozzles/ejection orifices, and onto media (e.g., a print medium).

The circuitry 202 such as a PCB can be disposed in the continuous molded compound 210, in some implementations. For instance, as illustrated in FIG. 2, the continuous molded compound can overlay a top face 205 of the circuitry 202 such as a PCB. That is, some or all faces of the circuitry 202 can be overlaid in the continuous molded compound 210 to promote aspects of molded fluidic die assemblies, in some implementations.

In some examples, a fluid ejection device can include an additional electrical device such as an addition fluidic die, a sensor, an ASIC, or other type of electrical device. In such examples, the additional electrical device can be surround by the continuous molded compound 210. For instance, the continuous molded compound can surround each fluidic die of a plurality of fluidic dies. However, in some examples, the continuous molded compound 210 can surround an electrical device other than a fluidic die, such as an ASIC or a sensor.

As illustrated in FIG. 2, the electrical connection 209 can couple the top face 205 of the circuitry 202 to the electrical component 223. Notably, the electrical component 223 and the fluidic architecture 231 (having the front face 203) can each be co-located on a first face 211 of the fluidic die 208-1. As used herein, a front face refers to a surface along which printing fluid can be dispensed from the fluidic die. While illustrated as being coupled to the top face 205, the disclosure is not so limited. Rather the electrical connection 209 can couple any face of the circuitry 202 to the first face 211 of the fluidic die 208-1. The electrical connection 209 can permit electrical signals (e.g., communication, data, and/or power) to be communicated between the fluidic die 208-1 and the circuitry 202. While illustrated as having one electrical connection 209, it is understood that a total number and/or relative locations of electrical connections between components (e.g., between the fluidic die 208-1 and the circuitry 202) can be varied.

As illustrated in FIG. 2, the electrical connection 209 can extend from the circuitry 202 around the fluidic die 208-1 to the first face 211 of the fluidic die. Stated differently, the electrical connection 209 does not pass through the fluidic die 208-1. Having the electrical connection 209 extend around a side face of the fluidic die 208-1 can promote readily encapsulating the electrical connection 209 (and any electrical components (e.g., bond pads) in the continuous molded compound 210 and/or can permit timing/cost-effect creation of fluidic dies, as compared to electrical connection extend through a via or other opening in the fluidic die 208-1.

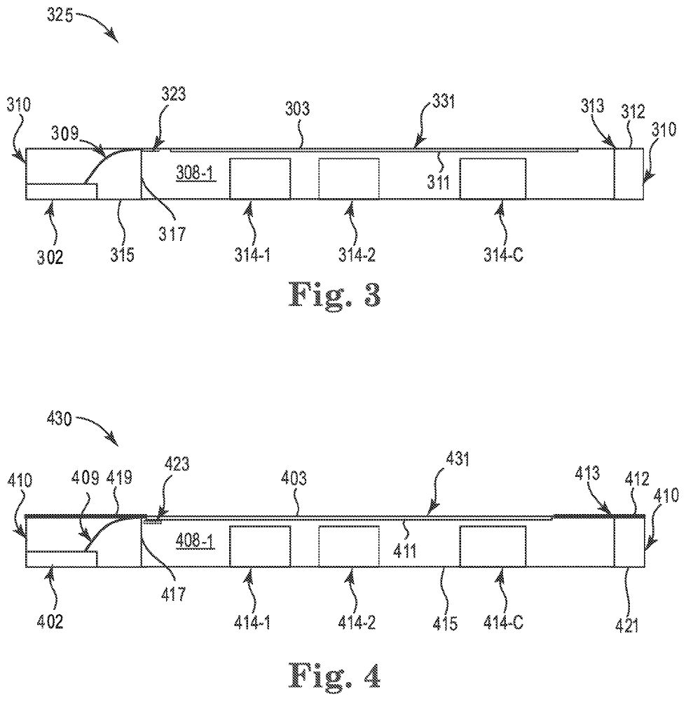

As illustrated in FIG. 2 (and similarly in FIGS. 3-6), in some instances a back face 215 of the fluidic die 208-1 can be electrical connection-free. As used herein, the back face 215 being electrical connection-free refers to the back face 215 being devoid of any electrical connects between the back face 215 of the fluidic die assembly and another component. For instance, the back face 215 can be free of any electrical connections between the back face 215 and another face and/or another component. In such instances, being electrical connection-free can provide an increased amount of surface area on the back face 215 for channels to pass through and/or can lead to a stronger fluidic die.

For instance, in some examples the fluidic die 208-1 can include a plurality of channels 214-1, 214-2, . . . , 214-C (hereinafter channels 214) extending through the back face 215 of the fluidic die 208-1, as illustrated in FIG. 2. The channels 214 can permit printing fluid to areas of a fluidic die such as the first face 211 and/or the front face 203 of the fluidic die 208-1. That is, the fluidic die 208-1 can include channels and/or other structures to permit a fluid ejection device including the fluidic die 208-1 to eject printing fluid. The shape and sizes of the channels 214 can be uniform or may not be uniform, in some instances, among other possible variations in the number, type, location, and/or size of the channels 214. For instance, the sidewalls of the channels 214 can be straight, angled, and/or curved, among other possibilities. The channels 214 can be formed via any suitable process such as etching, engraving, laser removal, among others.

As illustrated in FIG. 2, the continuous molded compound 210 can surround the fluidic die 208-1 and can encompass the electrical connection 209. For instance, the continuous molded compound can surround all side faces such as a side face 217 of the fluidic die 208-1.

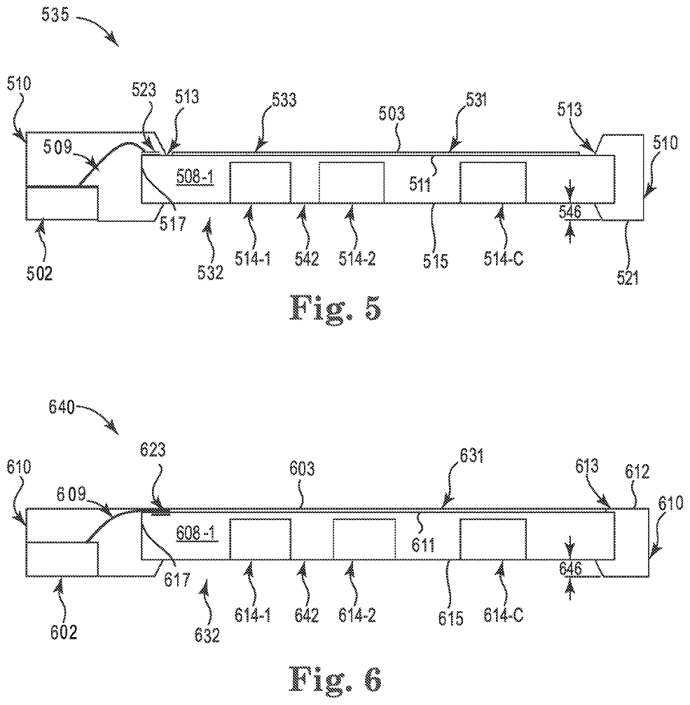

In some examples, the continuous molded compound 210 can overlay a portion of the front face 203, the first face 211 and/or the back face 215. For instance, the continuous molded compound 210 can overlay some but not all of the first face 211, as illustrated in FIG. 2. In such instances, the continuous molded compound 210 can overlay a periphery of the first face 211, but not overlay ejection orifices or other components (e.g., ejection orifices as represented by 533 in FIG. 5) the fluidic die which are to eject printing fluid.

As illustrated in FIG. 2, in some instance, the front face 203 of the fluidic die 208-1 can be recessed a distance 218 in the continuous molded compound 210. The distance 218 can be in a range from 0.05 micrometers to 250.00 micrometers. All individual values and subranges from 0.005 micrometers to 250.00 micrometers are included. Recessing the front face 203 the distance 218 can protect the fluidic die 208-1 and enable closer die-to-media spacing for enhanced print quality, in some instances. However, in some instances, the front face 203 of the fluidic die 208-1 and a top face 212 of the continuous molded compound 210 can be substantially coplanar, as detailed herein, rather than being recessed. In some examples, the electrical component 223 and/or the first face 211 can be recessed a respective distance that is equal to or greater than the distance 218. For instance, the electrical component 223 can be recessed an additional distance (relative the front face 203 the is recessed by distance 218) that is in a range from 10 to 100 micrometers.

An interface 213 is created between the continuous molded compound 210 and the fluidic die 208-1. The interface 213, like the continuous molded compound 210, extends around the periphery of the fluidic die 208-1 in an uninterrupted manner. As a result, the molded fluidic die assembly 220 has fewer material interfaces and/or less total distance of interfaces as compared to other approaches such as those that employ a dispensed adhesive or other encapsulation material/methods to encapsulate electrical connections.

Further as mentioned the electrical connection 209 is encompassed in the continuous molded compound 210. For ease of illustration FIG. 2 illustrates the electrical connection 209 as being visible; however, it is understood that that the entire exposed portion of the electrical connection 209 (e.g., the portion of the wire trace that remains exposed once the ends of the wire trace are coupled to the fluidic die 208-1 to the circuitry 202, respectively) is encompassed by the continuous molded compound 210. Stated differently, no surface of the electrical connection 209 is exposed once the electrical connection is encompassed by the continuous molded compound 210, in contrast to approaches such as those employing dispensed adhesives that can have voids/additional interfaces, and thereby expose a surface of an electrical connection.

FIG. 3 is another cross-sectional view of a portion of an example molded fluidic die assembly 325 according to the disclosure, as viewed from cross-sectional line A in FIG. 1. The molded fluidic die assembly 325 can include circuitry 302 and a fluidic die 308-1. The fluidic die 308-1 can include a first face 311, a back face 315 (including channels 314-1, 314-2, . . . , 314-C), and a side face 317. The fluidic die 308-1 can include an electrical component 323 and a fluidic architecture on the first face 311. The molded fluidic die assembly 325 can include a fluidic architecture 331. The fluidic architecture 331 can have a front face 303. The front face 303 is located on an opposite side of the fluidic architecture 331 from a side of the fluidic architecture that is adjacent to the first face 311. In some examples, the front face 303 can be parallel to the first face 311.

The molded fluidic die assembly 325 can include an electrical connection 309 coupling the circuitry 302 to the first face 311 of the fluidic die 308-1, such as to the electrical component 323 on the first face 311. As illustrated in FIG. 3, the molded fluidic die assembly 325 can include a continuous molded compound 310 that surrounds the fluidic die 308-1, encompasses the electrical connection 309, and forms an interface 313 between the continuous molded compound 310 and the fluidic die 308-1.

As illustrated in FIG. 3, in some instances the front face 303 of the fluidic die 308-1 can be substantially coplanar with a top face 312 of the continuous molded compound 310. Being substantially coplanar can comprise, for example, two faces that are parallel along a common plane and are spaced (in a direction orthogonal to the common plane) a distance apart from each other that is equal to or less than 0.05 micrometers.

FIG. 4 is yet another cross-sectional view of a portion of an example molded fluidic die assembly according to the disclosure, as viewed from cross-sectional line A in FIG. 1. The molded fluidic die assembly 430 can include circuitry 402, a fluidic die 408-1 (including a first face 411, a back face 415 (through which channels 414-1, 414-2, . . . , 414-C can extend), and a side face 417), a fluidic architecture 431 including a front face 403, an electrical component 423, and an electrical connection 409 coupling the circuitry 402 to the electrical component 423. The molded fluidic die assembly 430 can include a continuous molded compound 410, for instance, that surrounds the fluidic die 408-1, encompasses the electrical connection 409, and forms an interface 413. In some examples, face 421 of the continuous molded compound 410 can be substantially coplanar with the back face 415, as illustrated in FIG. 4.

As mentioned, the molded fluidic die assembly 430 can include a protective material. For instance, the protective material 419 can overlay the interface 413, as illustrated in FIG. 4. In this manner the protective material can mitigate or stop any potential ingress of fluid at interface 413. However, the disclosure is not so limited. Rather, the protective material can, in some examples, be overlaid on the interface 413, a top face 412 of the continuous molded compound 410, or a combination of the interface 413 and the top face 412.

Examples of suitable protective materials include various protective thin films and/or various laminated multilayer adhesive tapes having suitable barrier properties. While illustrated as being present in FIG. 4, it is understood that the protective material 419 can be present in other molded fluidic die assemblies (e.g., molded fluidic die assemblies described herein with respect to FIGS. 1, 2, 3, 5, 6, and/or 7).

FIG. 5 is an additional cross-sectional view of a portion of an example molded fluidic die assembly 535 according to the disclosure, as viewed from cross-sectional line A in FIG. 1. As illustrated in FIG. 5, the molded fluidic die assembly 535 can include a fluidic die 508-1 (including a first face 511, a back face 515 (through which channels 514-1, 514-2, . . . , 514-C can extend), and a side face 517), a fluidic architecture 531 including a front face 503, an electrical component 523, and an electrical connection 509 coupling the electrical component 523 of the fluidic die 508-1 to circuitry 502.

A continuous molded compound 510 can surround the fluidic die 508-1, encompass the electrical connection 509, and form interface 513 between the continuous molded compound 510 and the fluidic die 508-1. As illustrated in FIG. 5, the interface 513 can extend continuously along the first face 511, back face, and the side face 517, rather than having separate interfaces/materials at the first, side, and/or back faces of the fluidic die 508-1. As mentioned, the continuous molded compound 510 can overlay a periphery of the first face 511, and/or fluidic architecture 531, but not overlay ejection orifices (as represented by element 533) or other components the fluidic die 508-1 which are to eject printing fluid.

As illustrated in FIG. 5, the front face 503 can be recessed, as detailed herein, in the continuous molded compound 510. Similarly, the back face 515 can be recessed a distance 546 (which is equal to the distance between face 521 and the back face 515) in the continuous molded compound 510. In some examples, the back face 515 can be recessed and define a portion of a fluid feed slot 532 that is adjacent to the back face 515, The fluid feed slot 532 can fluidically couple the fluidic die 508-1 to a fluid reservoir (not illustrated) when the fluid reservoir is present in a fluid ejection device including the molded fluidic die assembly 535. For instance, the fluid feed slot 532 can provide printing fluid to channels 514-1, 514-2, . . . , 514-C.

FIG. 6 is a further cross-sectional view of a portion of an example molded fluidic die assembly 640 according to the disclosure, as viewed from cross-sectional line A in FIG. 1. As illustrated in FIG. 6, the molded fluidic die assembly 640 can include a fluidic die 608-1, The fluidic die 608-1 can include a first face 611, a back face 615, and a side face 617. Channels 614-1, 614-2, . . . , 614-C can extend and/or defining a portion of a fluid feed slot 632 that is adjacent to the back face 615.

The fluidic die 608-1 can include an electrical component 623 and a fluidic architecture 631 (including a front face 603). As mentioned, an electrical connection 609 can couple an electrical component 623 on the first face 611 of the fluidic die 608-1 to circuitry 602. A continuous molded compound 610 can surround the fluidic die 608-1, encompass the electrical connection 609, and form interface 613.

As illustrated in FIG. 6, the front face 603 of the fluidic die 608-1 can be substantially coplanar, as described herein, with a top face 612 of the continuous molded compound 610. As illustrated in FIG. 6, in some examples the back face 615 can be recessed a distance 646, as discussed herein, in the continuous molded compound 610.

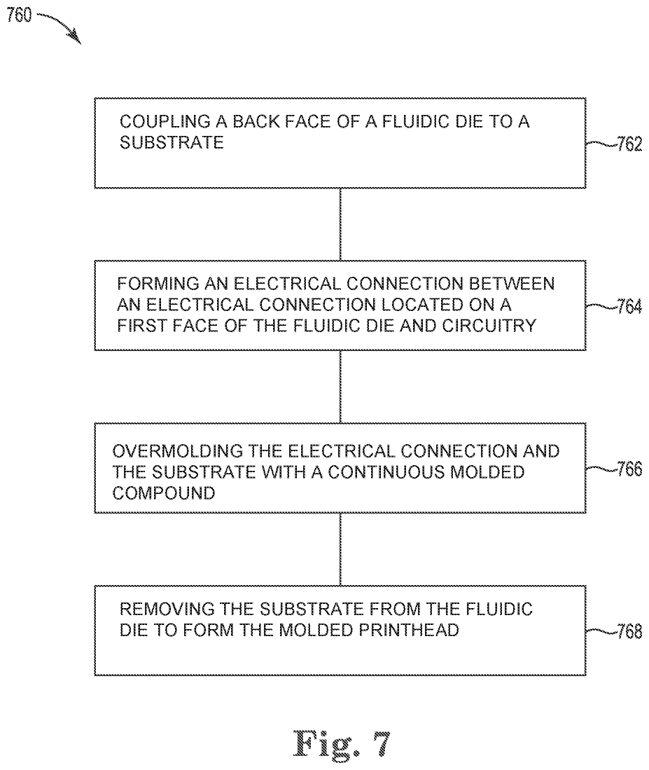

FIG. 7 is a flow diagram of an example of a method 760 of forming a molded fluidic die assembly according to the disclosure. At 762 the method 760 can include coupling a fluidic die to a substrate. Examples of substrates include sacrificial substrates and/or carriers, among other types of substrates to which a fluidic die can be coupled.

The fluidic die can be coupled to the substrate via a mechanical mechanism, chemical process, etc. For instance, coupling can employ ultrasound welding, a mechanical connector (such as a clamp, clip, and/or components sized for a friction fit, etc.) and/or adhesion via use of an adhesive, etc. Notably, method 760 can employ industry standard tooling, as opposed to using dispensed encapsulation material or other approaches that may rely on custom tooling.

At 764 the method 760 can include forming an electrical connection between an electrical component located on a first face of the fluidic die and circuitry. For instance, an electrical component such as a bond pad on a first face of a fluidic die can be coupled via an electrical connection to a corresponding electrical component on circuitry. The circuitry can be included in and/or coupled to the substrate.

At 766 the method 760 can include overmolding the electrical connection and the substrate with a continuous molded compound. Overmolding can occur a pressure above ambient pressure and thereby avoid the presence of voids in the continuous molded compound, as compared to dispensed adhesives or other types of encapsulation materials dispensed at an ambient pressure. Overmolding can also provide enhanced positional precision of the material interfaces compared to using dispensed encapsulation materials such as adhesives.

At 768 the method 760 can include removing the substrate from the fluidic die to form the molded fluidic die assembly. Removal can be accomplished by any mechanism such as mechanical removal (e.g., via abrasion, sand blasting, cutting, etc.) and/or chemical removal. In some examples, the entire substrate is removed.

In some examples, the method can include coupling the back face of the fluidic die via an adhesive to the substrate. In such examples, the method 760 can include removing the substrate and the adhesive, for instance, responsive to coupling the fluidic die to circuitry. For example, the entire substrate, all adhesive, and/or the entire substrate and all adhesive can be removed from the fluidic die to form a molded fluidic die assembly.

In some examples, the method 760 can include providing a component such as a fluidic die, a substrate, circuitry, and/or a continuous molded material, among other components to form a molded fluidic die assembly. As used herein, providing can include manufacture or otherwise procuring components to form a molded fluidic die assembly.

In the foregoing detailed description of the present disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the present disclosure.

The figures herein follow a numbering convention in which the first digit or digits correspond to the drawing figure number and the remaining digits identify an element or component in the drawing. Similar elements or components between different figures can be identified by the use of similar digits. For example, 110 can reference element “10” in FIG. 1, and a similar element can be referenced as 210 in FIG. 2. Multiple analogous elements within one figure can be referenced with a reference numeral followed by a hyphen and another numeral or a letter. For example, 108-1 can reference element 08-1 in FIGS. 1 and 108-2 can reference element 08-2, which can be analogous to element 08-1. Such analogous elements can be generally referenced without the hyphen and extra numeral or letter. For example, elements 108-1 and 108-2 can be generally referenced as 108.

Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure and should not be taken in a limiting sense. As used herein, the designator “c” and “n” particularly with respect to reference numerals in the drawings, indicates that a number of the particular feature so designated can be included with examples of the present disclosure. The designators can represent the same or different numbers of the particular features.

What is claimed is:

1. A molded fluidic die assembly comprising:
a fluidic die including an electrical component and a fluidic architecture on a first face of the fluidic die, the fluidic architecture including a front face;
circuitry;
an electrical connection coupling the circuitry to the electrical component on the first face of the fluidic die; and
a continuous molded compound that surrounds the fluidic die and encompasses the electrical connection.

2. The molded fluidic die assembly of claim 1, wherein the electrical connection includes a wire trace, solder joint, Tape Automated Bond (TAB), or combinations thereof.

3. The molded fluidic die assembly of claim 1, wherein the circuitry is a printed circuit board, and wherein a face of the printed circuit board is overlaid with the continuous molded compound.

4. The molded fluidic die assembly of claim 1, wherein the front face includes ejection orifices.

5. The molded fluidic die assembly of claim 1, wherein the front face of the fluidic die is recessed a distance in the continuous molded compound, and wherein distance is in a range from 0.05 micrometers to 250.00 micrometers.

6. The molded fluidic die assembly of claim 1, wherein the front face of the fluidic die is substantially coplanar with a top face of the continuous molded compound.

7. The molded fluidic die assembly of claim 1, further comprising a protective material, wherein the protective material is overlaid on an interface between the continuous molded compound and the fluidic die, on a top face of the continuous molded compound, or on both of the interface and the top face.

8. A fluid ejection device comprising:
a body; and
a molded fluidic die assembly comprising:
a fluidic die including a first face, an electrical component and a fluidic architecture with a front face, wherein the electrical component and the fluidic architecture are each located on the first face of the fluidic die;
an electrical connection between the electrical component and circuitry; and
a continuous molded compound that surrounds the fluidic die and encompasses the electrical connection.

9. The fluid ejection device of claim 8, wherein the fluidic die includes a back face opposite the front face, and wherein the back face of the fluidic die is electrical connection-free.

10. The fluid ejection device of claim 8, wherein the continuous molded compound is an epoxy molding compound (EMC).

11. The fluid ejection device of claim 8, wherein the fluid ejection device is adhesive-free.

12. The fluid ejection device of claim 8, wherein the fluid ejection device is shroud-free.

13. The fluid ejection device of claim 8, wherein the fluidic die includes a back face opposite the front face, and wherein the continuous molded compound defines a fluid feed slot to the back face of the fluidic die.

14. A method comprising:
coupling a back face of a fluidic die to a substrate;
forming an electrical connection between an electrical connection located on a first face of the fluidic die and circuitry;
overmolding the electrical connection and the substrate with a continuous molded compound; and
removing the substrate from the fluidic die to form a molded fluidic die assembly.

15. The method of claim 14, further comprising:
coupling the back face of the fluidic die via an adhesive to the substrate; and
removing the substrate and the adhesive from the fluidic die to form the molded fluidic die assembly.
